(19) United States
(12) Patent Application Publication
(10) Pub. No.: US 2022/0410672 A1
(43) Pub. Date: Dec. 29, 2022

(54) TOUCH DISPLAY SYSTEM AND DRIVING METHOD THEREOF, AND VEHICLE

(71) Applicants: Beijing BOE Sensor Technology Co., Ltd., Beijing (CN); BOE TECHNOLOGY GROUP CO., LTD., Beijing (CN)

(72) Inventors: Zhong HU, Beijing (CN); Chen MENG, Beijing (CN); Yuelei XIAO, Beijing (CN); Jiarong LIU, Beijing (CN); Binbin LIU, Beijing (CN); Dahai HU, Beijing (CN); Yutao TANG, Beijing (CN); Yongbo WANG, Beijing (CN)

(73) Assignees: Beijing BOE Sensor Technology Co., Ltd., Beijing (CN); BOE TECHNOLOGY GROUP CO., LTD., Beijing (CN)

(21) Appl. No.: 17/778,226

(22) PCT Filed: May 12, 2021
(86) PCT No.: PCT/CN2021/093435

§ 371 Date: May 19, 2022

(30) Foreign Application Priority Data
Jun. 22, 2020 (CN) 202010575612.9

(51) Int. Cl. B60J 3/04; G06F 3/042; B60K 35/00; G06F 3/041; G06F 3/0488

(52) U.S. Cl. CPC B60J 3/04; G06F 3/0421; B60K 35/00; G06F 3/0412; G06F 3/0488; B60K 2370/143; B60K 2370/27; B60K 2370/785; B60K 2370/52

(57) ABSTRACT

A touch display system includes: a piece of dimming glass; a transparent display screen provided on a side of the piece of dimming glass; an infrared touch apparatus; and a controller electrically connected to the piece of dimming glass, the display screen, and the infrared touch apparatus. The infrared touch apparatus is configured to generate an infrared detection net on a side of the display screen away from the piece of dimming glass; and the controller is configured to control the infrared touch apparatus to sense a touch action of a user, obtain a touch signal sensed by the infrared touch apparatus, and adjust a display image on the display screen and/or a light transmittance of the piece of dimming glass according to the touch signal.

### CROSS-REFERENCE TO RELATED APPLICATIONS

This application is a national phase entry under 35 USC 371 of International Patent Application No. PCT/CN2021/093435, filed on May 12, 2021, which claims priority to Chinese Patent Application No. 202010575612.9, filed on Jun. 22, 2020, which are incorporated herein by reference in their entirety.

### TECHNICAL FIELD

The present disclosure relates to the field of display technologies, and in particular, to a touch display system, a driving method therefor and a vehicle.

### BACKGROUND

With the development of artificial intelligence technologies, it has been possible to provide a transparent display screen in a window of a vehicle. In this case, when a user (e.g., including a passenger, an owner of a vehicle) is on the way by vehicle, the user may not only read news, watch videos, or visit on-line stores through the display screen provided on the window, but also see a scene outside the vehicle through the transparent display screen.

### SUMMARY

In an aspect, a touch display system is provided. The touch display system includes: a piece of dimming glass, a transparent display screen disposed on a side of the piece of dimming glass, an infrared touch apparatus, and a controller electrically connected to the piece of dimming glass, the display screen and the infrared touch apparatus. The infrared touch apparatus is configured to generate an infrared detection net on a side of the display screen away from the piece of dimming glass. The controller is configured to control the infrared touch apparatus to sense a touch action of a user, obtain a touch signal sensed by the infrared touch apparatus, and adjust at least one of a display image on the display screen and a light transmittance of the piece of dimming glass according to the touch signal.

In some embodiments, the piece of dimming glass includes at least one piece of dimming sub-glass. Each piece of dimming sub-glass includes: a transparent first substrate; a transparent second substrate, the first substrate and the second substrates being disposed opposite to each other; and a dye liquid crystal layer disposed between the first substrate and the second substrate.

In some embodiments, the piece of dimming glass includes a plurality of pieces of dimming sub-glass that are arranged in sequence. Among the plurality of pieces of dimming sub-glass, long axes of liquid crystal molecules in dye liquid crystal layers of at least two pieces of dimming sub-glass are substantially perpendicular to each other.

In some embodiments, among the plurality of pieces of dimming sub-glass, dyes in dye liquid crystal layers of at least two pieces of dimming sub-glass have different colors.

In some embodiments, every two adjacent pieces of dimming sub-glass share a same substrate on sides of the two adjacent pieces of dimming sub-glass proximate to each other.

In some embodiments, the substrate includes a base substrate, and electrode layers disposed on opposite sides of the base substrate.

In some embodiments, the piece of dimming glass has a plurality of dimming regions. The controller is configured to independently adjust a light transmittance of each dimming region in the piece of dimming glass.

In some embodiments, the dimming regions have a strip shape, a direction in which lengths of the dimming regions extend is a second direction, and the plurality of dimming regions are arranged sequentially in a first direction. The first direction intersects with the second direction.

In some embodiments, the dimming regions have a square shape, and are arranged in an array.

In some embodiments, in a case where the piece of dimming glass includes at least one piece of dimming sub-glass, and each piece of dimming sub-glass includes a first substrate, a second substrate and a dye liquid crystal layer, the first substrate includes a first electrode layer, the first electrode layer includes a plurality of first electrodes, and one first electrode is located in a dimming region; and the second substrate includes a second electrode layer, the second electrode layer includes a plurality of second electrodes and one second electrode is located in the dimming region in which the first electrode is located, or the second electrode layer covers the plurality of dimming regions.

In some embodiments, the infrared touch apparatus includes: a frame, the frame including two groups of sub-frames, and each group of sub-frames including two sub-frames that are disposed opposite to each other; and a plurality of infrared devices disposed on an inner wall of each sub-frame, the plurality of infrared devices being located on the side of the display screen away from the piece of dimming glass. In two sub-frames that are disposed opposite to each other, infrared devices disposed on an inner wall of one of the two sub-frames are infrared transmitters, infrared devices disposed on an inner wall of another of the two sub-frames are infrared detectors, and one infrared transmitter is disposed opposite to one infrared detector.

In some embodiments, the sub-frames have a straight line shape, and ends of every two adjacent sub-frames are connected to each other. Infrared devices disposed on inner walls of all sub-frames are disposed in a same plane parallel to the display screen.

In some embodiments, the frame further includes at least one transition portion having an arc shape, and a transition portion is connected between ends, proximate to each other, of two adjacent sub-frames. The two sub-frames connected to the transition portion are respectively a first sub-frame and a second sub-frame. An inner wall of the transition portion is provided with a first group of infrared devices and a second group of infrared devices thereon. The first group of infrared devices and infrared devices disposed on the first sub-frame have a same type and are located in a first plane, and the second group of infrared devices and infrared devices disposed on the second sub-frame have a same type and are located in a second plane. The first plane and the second plane are different planes that are parallel to the display screen.

In some examples, every two adjacent sub-frames are connected to a transition portion therebetween.

In some embodiments, the frame is disposed around the piece of dimming glass and the display screen.

In another aspect, a driving method for a touch display system is provided, which is applied to the touch display system described in any of the above embodiments. The driving method includes: controlling, by the controller, the infrared touch apparatus to sense the touch action of the user; generating, by the infrared touch apparatus, the touch signal according to the touch action, and transmitting, by the infrared touch apparatus, the touch signal to the controller; and adjusting, by the controller, at least one of the display image on the display screen and the light transmittance of the piece of dimming glass according to the touch signal.

In yet another aspect, a vehicle is provided. The vehicle includes: a vehicle body, the vehicle body having a plurality of windows; and at least one touch display system according to any of the above embodiments. At least one window is provided therein with the piece of dimming glass, the transparent display screen and the infrared touch apparatus of a touch display system.

In some embodiments, the controller of the touch display system is disposed inside the vehicle body.

### BRIEF DESCRIPTION OF THE DRAWINGS

In order to describe technical solutions in the present disclosure more clearly, accompanying drawings to be used in some embodiments of the present disclosure will be introduced briefly below. Obviously, the accompanying drawings to be described below are merely accompanying drawings of some embodiments of the present disclosure, and a person of ordinary skill in the art may obtain other drawings according to these drawings. In addition, the accompanying drawings to be described below may be regarded as schematic diagrams, but are not limitations on actual sizes of products and actual processes of methods to which the embodiments of the present disclosure relate.

FIG. 1 is a diagram showing a structure of a touch display system, in accordance with some embodiments of the present disclosure;

FIG. 2 is a diagram showing a structure of another touch display system, in accordance with some embodiments of the present disclosure;

FIG. 3 is a diagram showing a structure of a piece of dimming glass, in accordance with some embodiments of the present disclosure;

FIG. 4 is a diagram showing a structure of another piece of dimming glass, in accordance with some embodiments of the present disclosure;

FIG. 5 is a diagram showing a structure of yet another piece of dimming glass, in accordance with some embodiments of the present disclosure;

FIG. 6 is a diagram showing a structure of yet another piece of dimming glass, in accordance with some embodiments of the present disclosure;

FIG. 7 is a diagram showing a structure of yet another piece of dimming glass, in accordance with some embodiments of the present disclosure;

FIG. 8 is a diagram showing a structure of a piece of dimming glass in a transparent state, in accordance with some embodiments of the present disclosure;

FIG. 9 is a diagram showing a structure of a piece of dimming glass in an opaque state, in accordance with some embodiments of the present disclosure;

FIG. 10 is a top view of a piece of dimming glass, in accordance with some embodiments of the present disclosure;

FIG. 11 is a top view of another piece of dimming glass, in accordance with some embodiments of the present disclosure;

FIG. 12 is a diagram showing a structure of an infrared touch apparatus, in accordance with some embodiments of the present disclosure;

FIG. 13 is a diagram showing a structure of another infrared touch apparatus, in accordance with some embodiments of the present disclosure;

FIG. 14 is a distribution diagram of a part of infrared devices in the infrared touch apparatus shown in FIG. 13;

FIG. 15 is a distribution diagram of another part of infrared devices in the infrared touch apparatus shown in FIG. 13;

FIG. 16 is a distribution diagram of a part of infrared devices in an infrared touch apparatus, in accordance with some embodiments of the present disclosure;

FIG. 17 is a distribution diagram of another part of infrared devices in an infrared touch apparatus, in accordance with some embodiments of the present disclosure;

FIG. 18 is a flow diagram of a driving method for a touch display system, in accordance with some embodiments of the present disclosure; and

FIG. 19 is a diagram showing a structure of a vehicle, in accordance with some embodiments of the present disclosure.

### DETAILED DESCRIPTION

Technical solutions in some embodiments of the present disclosure will be described clearly and completely with reference to the accompanying drawings below. Obviously, the described embodiments are merely some but not all embodiments of the present disclosure. All other embodiments obtained by a person of ordinary skill in the art based on the embodiments of the present disclosure shall be included in the protection scope of the present disclosure.

Unless the context requires otherwise, throughout the description and the claims, the term “comprise” and other forms thereof such as the third-person singular form “comprises” and the present participle form “comprising” are construed as an open and inclusive meaning, i.e., “including, but not limited to”. In the description of the specification, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials, or characteristics may be included in any one or more embodiments or examples in any suitable manner.

Hereinafter, terms such as “first” and “second” are used for descriptive purposes only, and are not to be construed as indicating or implying the relative importance or implicitly indicating the number of indicated technical features. Thus, features defined by “first” or “second” may explicitly or implicitly include one or more of the features. In the description of the embodiments of the present disclosure, unless otherwise specified, the term “a plurality of” or “the plurality of” means two or more.

In the description of some embodiments, the expressions “connected” and its extension may be used. For example, the term “connected” may be used in the description of some embodiments to indicate that two or more components are in direct physical or electrical contact with each other. The embodiments disclosed herein are not necessarily limited to the contents herein.

The phrase “A and/or B” includes the following three combinations: only A, only B, and a combination of A and B.

As used herein, the term “if” is optionally construed as “when” or “in a case where” or “in response to determining that” or “in response to detecting”, depending on the context. Similarly, depending on the context, the phrase “if it is determined that” or “if [a stated condition or event] is detected” is optionally construed as “in a case where it is determined that” or “in response to determining that” or “in a case where [the stated condition or event] is detected” or “in response to detecting [the stated condition or event]”.

The use of the phrase “applicable to” or “configured to” herein means an open and inclusive language, which does not exclude apparatuses that are applicable to or configured to perform additional tasks or steps.

In addition, the use of the phrase “based on” is meant to be open and inclusive, since a process, step, calculation, or other action that is “based on” one or more of the stated conditions or values may, in practice, be based on additional conditions or values exceeding those stated.

As used herein, the term “about” or “approximately” includes a stated value and an average value within an acceptable range of deviation of a particular value. The acceptable range of deviation is determined by a person of ordinary skill in the art, in consideration of measurement in question and errors associated with the measurement of a particular quantity (i.e., limitations of a measurement system).

Exemplary embodiments are described herein with reference to sectional views and/or plan views as idealized exemplary drawings. In the accompanying drawings, thicknesses of layers and sizes of regions are enlarged for clarity. Variations in shape with respect to the accompanying drawings due to, for example, manufacturing techniques and/or tolerances may be envisaged. Therefore, the exemplary embodiments should not be construed as being limited to the shapes of the regions shown herein, but including deviations due to, for example, manufacturing. For example, an etched region shown in a rectangular shape generally has a curved feature. Therefore, the regions shown in the accompanying drawings are schematic in nature, and their shapes are not intended to show actual shapes of the regions in an apparatus, and are not intended to limit the scope of the exemplary embodiments.

In a case where the outside of a vehicle is bright and thus the inside of the vehicle is bright, the user may have a demand for unfolding a curtain to block light entering from the outside of the vehicle to the inside of the vehicle through a window. In this case, if the curtain is unfolded, a display screen disposed in the window will be blocked, and it is difficult to read news, watch videos, or visit on-line stores through the display screen.

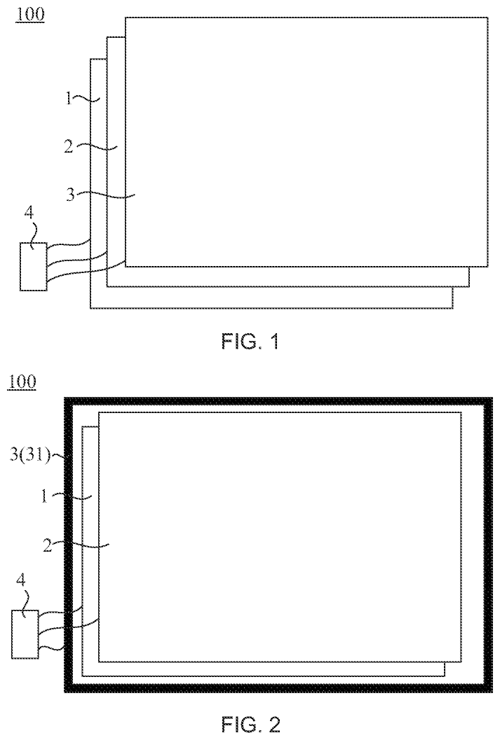

On this basis, in some embodiments of the present disclosure, a touch display system 100 is provided. As shown in FIGS. 1 and 2, the touch display system 100 includes a piece of dimming glass 1, a display screen 2, an infrared touch apparatus 3, and a controller 4 electrically connected to the piece of dimming glass 1, the display screen 2 and the infrared touch apparatus 3.

In some embodiments, the display screen 2 is a transparent display screen 2. In this way, in a case where the display screen 2 displays images, the user may browse the images; in a case where the display screen 2 stops displaying the images, the display screen 2 is similar to a transparent glass in appearance, so that the user may view a scene outside the window of the vehicle through the display screen 2.

In some examples, the display screen 2 has various structures, which may be selected and set according to actual needs. For example, the display screen 2 may be a transparent organic light-emitting diode (OLED) display screen. For another example, the display screen 2 may be a transparent liquid crystal display (LCD).

The piece of dimming glass 1 has various types, which may be selected and set according to actual needs. For example, the piece of dimming glass 1 may be a piece of electric-control dimming glass, a piece of temperature-control dimming glass, a piece of light-control dimming glass, or a piece of pressure-control dimming glass.

A structure of the piece of dimming glass 1 will be schematically described below by considering an example where the piece of dimming glass 1 is the piece of electric-control dimming glass.

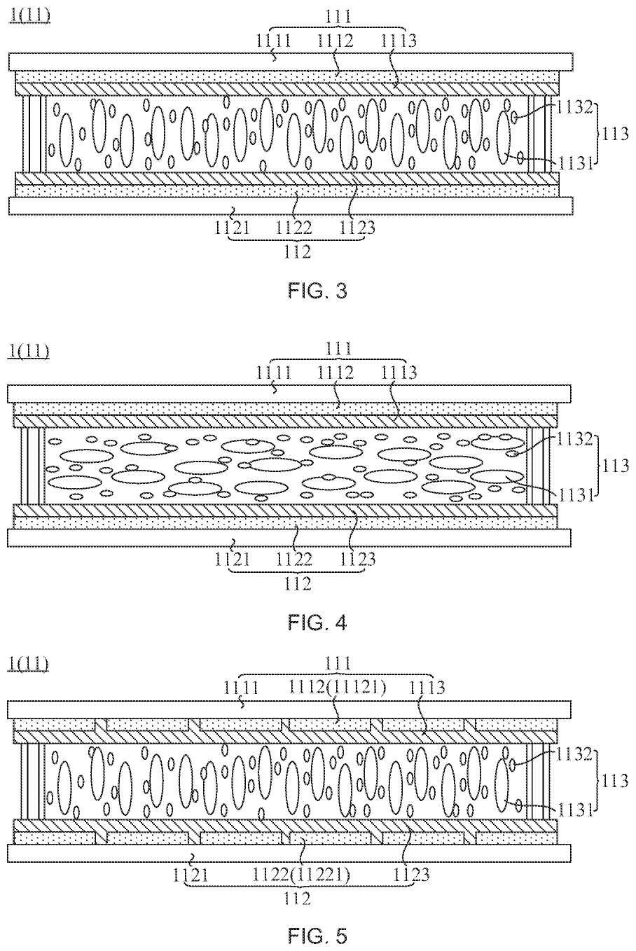

In some embodiments, as shown in FIGS. 3 to 8, the piece of dimming glass 1 includes at least one piece of dimming sub-glass 11. Each piece of dimming sub-glass 11 includes a first substrate 111 and a second substrate 112 that are disposed opposite to each other, and a dye liquid crystal layer 113 disposed between the first substrate 111 and the second substrate 112.

Here, the structure of the piece of dimming glass 1 will be schematically described by considering an example where the piece of dimming glass 1 includes one piece of dimming sub-glass 11.

In some examples, as shown in FIGS. 3 to 6, the first substrate 111 includes a first base substrate 1111, a first electrode layer 1112 disposed on a side of the first base substrate 1111 proximate to the second substrate 112, and a first alignment layer 1113 disposed on a side of the first electrode layer 1112 proximate to the second substrate 112. The second substrate 112 includes a second base substrate 1121, a second electrode layer 1122 disposed on a side of the second base substrate 1121 proximate to the first substrate 111, and a second alignment layer 1123 disposed on a side of the second electrode layer 1122 proximate to the first substrate 111.

In some examples, as shown in FIGS. 3 to 6, the dye liquid crystal layer 113 includes liquid crystal molecules 1131 and dyes 1132 that are capable of absorbing light.

In the dye liquid crystal layer 113, long axes of the dyes 1132 are parallel or substantially parallel to long axes of the liquid crystal molecules 1131. In a case where the liquid crystal molecules 1131 are deflected, the dyes 1132 rotate in a same phase with the liquid crystal molecules 1131 due to action of forces among the liquid crystal molecules. Rotation angles of the dyes 1132 are different, and light absorptivity of the dyes 1132 are different.

For example, the piece of dimming sub-glass 11 is a piece of dimming glass in a normally white mode.

On this basis, in a case where there is no driving voltage applied to the first electrode layer 1112 and the second electrode layer 1122, as shown in FIG. 3, in the dye liquid crystal layer 113, the long axes of the liquid crystal molecules 1131 and the long axes of the dyes 1132 are all perpendicular or substantially perpendicular to the first alignment layer 1113 (or the second alignment layer 1123). In this case, when light is incident on the piece of dimming sub-glass 11, since the dyes 1132 do not substantially absorb light, or only absorb a little part of light, and the dyes 1132 occupy a few area on a plane where the piece of dimming sub-glass 11 is located, most of light may be transmitted through the piece of dimming sub-glass 11, thereby making the piece of dimming sub-glass 11 substantially in a transparent state.

In a case where the driving voltages are transmitted to the first electrode layer 1112 and the second electrode layer 1122 (e.g., a voltage transmitted to the first electrode layer 1112 is a positive voltage, and a voltage transmitted to the second electrode layer 1122 is a negative voltage), as shown in FIG. 4, the first electrode layer 1112 and the second electrode layer 1122 may generate an electric field therebetween. The electric field may drive the liquid crystal molecules 1131 in the dye liquid crystal layer 113 to deflect, and the liquid crystal molecules 1131 may drive the dyes 1132 to rotate during the deflection process. For example, as shown in FIG. 4, the liquid crystal molecules 1131 are deflected to a direction in which the long axes of the liquid crystal molecules 1131 are parallel or substantially parallel to the first alignment layer 1113 (or the second alignment layer 1123), and drive the dyes 1132 to rotate until the long axes of the dyes 1132 are parallel or substantially parallel to the first alignment layer 1113 (or the second alignment layer 1123). In this case, when light is incident on the piece of dimming sub-glass 11, since the dyes 1132 may absorb most or all of light, and the dyes 1132 occupy a large area on the plane where the piece of dimming sub-glass 11 is located, it is difficult for light to be transmitted through the piece of dimming sub-glass 11 (it is not excluded a condition that a little part of light may be transmitted through the piece of dimming sub-glass 11), so that the piece of dimming sub-glass 11 is substantially in an opaque state.

In this way, in a case where the touch display system 100 is provided in the window of the vehicle, the piece of dimming glass 1 (i.e., the piece of dimming sub-glass 11) may have a function of a traditional curtain. That is, in a case where the driving voltages are applied to the piece of dimming glass 1, the piece of dimming glass 1 may be used to absorb light entering from the outside to the inside of the vehicle (it is equivalent to a situation where the curtain is unfolded to block light), so as to reduce the brightness inside the vehicle. In a case where the driving voltages are stopped applying to the piece of dimming glass 1, it is possible to prevent the piece of dimming glass 1 from absorbing light entering from the outside to the inside of the vehicle (it is equivalent to a situation where the curtain is folded not to block light), so that the inside of the vehicle has high brightness. Moreover, the touch display system 100 is provided in the window of the vehicle, and the piece of dimming glass 1 may be used to replace the traditional curtain, so as to avoid additionally providing the traditional curtain, thereby reducing complexity of an internal structure of the vehicle and a probability of abnormality in the internal structure of the vehicle.

In some examples, as shown in FIGS. 1 and 2, the display screen 2 is disposed on a side of the piece of dimming glass 1. For example, the side of the piece of dimming glass 1 may be a side of the piece of dimming glass 1 proximate to the inside of the vehicle. In this way, in a case where the piece of dimming glass 1 is in the opaque state, it may avoid affecting the user's browsing of the images displayed on the display screen 2.

In some examples, in a case where the touch display system 100 is disposed in the window of the vehicle, arrangement positions of the first substrate 111 and the second substrate 112 may be selected and set according to actual needs.

For example, the first substrate 111 may be closer to the inside of the vehicle than the second substrate 112, and the second substrate 112 may be closer to the outside of the vehicle than the first substrate 111. For another example, the second substrate 112 may be closer to the inside of the vehicle than the first substrate 111, and the first substrate 111 may be closer to the outside of the vehicle than the second substrate 112.

In some examples, the first substrate 111 and the second substrate 112 are both transparent substrates. That is, materials of various structures included in the first substrate 111 and materials of various structures included in the second substrate 112 are transparent materials. In this way, it may prevent the first substrate 111 and the second substrate 112 from adversely affecting a light propagation process, so that the piece of dimming sub-glass 11 has a good light transmittance in the transparent state.

For example, the first base substrate 1111 and the second base substrate 1121 may be glass base substrates. In this way, it may ensure that the piece of dimming sub-glass 11 has a certain strength, and it may avoid affecting the light transmittance of the piece of dimming sub-glass 11 in a case where the piece of dimming sub-glass 11 is in the transparent state.

For example, a material of the first electrode layer 1112 and a material of the second electrode layer 1122 may be same or different. For example, the material of the first electrode layer 1112 and the material of the second electrode layer 1122 are the same, and the material may be indium tin oxide (ITO), indium zinc oxide (IZO) or indium gallium zinc oxide (IGZO). In this way, the piece of dimming sub-glass 11 may have the good light transmittance and avoid adversely affecting the light transmittance of the piece of dimming sub-glass 11 due to the arrangement of the first electrode layer 1112 and the second electrode layer 1122.

For example, a material of the first alignment layer 1113 and a material of the second alignment layer 1123 may be same or different. For example, the material of the first alignment layer 1113 and the material of the second alignment layer 1123 are the same, and the material may be a mixture of polyimide, N-methyl-2pyrrolidone and 2-butoxyethanol, or a polymer of hydroxyethyl acrylate, 3-isocyanatomethylene-3, 5,5-trimethylcyclohexyl isocyanate, bisphenol propane or 1,4-cyclohexanediol. In this way, in a case where the piece of dimming sub-glass 11 is in the transparent state, it is possible to avoid affecting the light transmittance of the piece of dimming sub-glass 11.

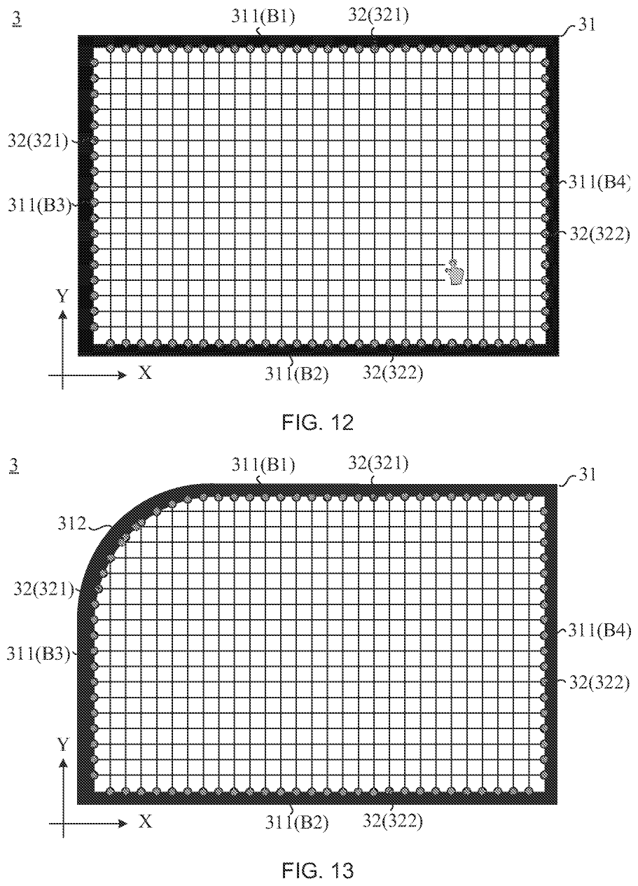

In some embodiments, as shown in FIGS. 12 and 13, the infrared touch apparatus 3 is configured to generate an infrared detection net on a side of the display screen 2 away from the piece of dimming glass 1 (i.e., on a side of the display screen 2 proximate to the inside of the vehicle).

In some examples, as shown in FIG. 12, the infrared detection net may be, for example, an infrared matrix composed of a plurality of infrared rays extending in a first direction X and a plurality of infrared rays extending in a second direction Y. In a case where the user touches the display screen 2, infrared rays (including infrared rays extending in the first direction X and infrared rays extending in the second direction Y) corresponding to a touch position may be blocked. A touch action of the user may be sensed by determining coordinates of the blocked infrared rays.

Here, the user may touch the display screen 2 by using any object that may block light, such as a pen or a finger.

In some examples, the first direction X intersects with the second direction Y.

An included angle between the first direction X and the second direction Y may be selected and set according to actual needs.

For example, the first direction X may be perpendicular to the second direction Y. That is, the included angle between the first direction X and the second direction Y is 90°. For another example, the first direction X may not be perpendicular to the second direction Y. That is, the included angle between the first direction X and the second direction Y may not equal to 90°. The included angle between the first direction X and the second direction Y may be, for example, 89°, 85°, or 84°.

In some embodiments, the controller 4 is configured to control the infrared touch apparatus 3 to sense the touch action of the user, obtain a touch signal sensed by the infrared touch apparatus 3, and adjust a display image on the display screen 2 and/or a light transmittance of the piece of dimming glass 1 according to the touch signal.

In some examples, the touch action includes various types. For example, the touch action may include a single-click, a double-click, a sliding motion in the first direction X, a sliding motion in the second direction Y, or a motion for drawing a circle. However, the touch actions are not limited to the examples.

Here, the touch actions may be classified into at least two types. For example, the touch actions are classified into three types, one type of touch actions (e.g., the single-click, or the sliding motion in the second direction Y) corresponds to the display screen 2, and another type of touch actions (e.g., the motion for drawing a circle, or the sliding motion in the first direction X) corresponds to the piece of dimming glass 1, and yet another type of touch actions (e.g., the double-click) corresponds to both the display screen 2 and the piece of dimming glass 1. In this way, the controller 4 may adjust the display image on the display screen 2 and/or the light transmittance of the piece of dimming glass 1 according to the type of the touch action.

A process of the controller 4 adjusting the display image on the display screen and/or the light transmittance of the piece of dimming glass 1 is schematically described below. For example, the controller 4 stores protocols corresponding to various touch actions.

For example, the user clicks on the display screen 2. In this case, the controller 4 controls the infrared touch apparatus 3 to determine the coordinates of the blocked infrared rays in the infrared detection net, and senses that the touch action of the user is the single-click according to the coordinates. Afterwards, the infrared touch apparatus 3 may generate a corresponding touch signal. Then the controller 4 may obtain the touch signal, and adjust the display image on the display screen 2 upon determining that the touch signal corresponds to the display screen 2. For example, before the user clicks on the display screen 2, the image displayed on the display screen 2 is an image of a piece of clothing. After the user clicks on the display screen 2 (e.g., a position where the user clicks on the display screen 2 is same as a position of the image of the clothing), the controller 4 controls the display screen 2 to change the displayed image to an introduction of the clothing (e.g., a brand or a price of the clothing).

For example, the user slides on the display screen 2 in the first direction X. In this case, the controller 4 controls the infrared touch apparatus 3 to determine the coordinates of the blocked infrared rays in the infrared detection net, and senses that the touch action of the user is the sliding motion in the first direction X according to the coordinates. Afterwards, the infrared touch apparatus 3 may generate a corresponding touch signal. Then the controller 4 may obtain the touch signal, and adjust the light transmittance of the piece of dimming glass 1 upon determining that the touch signal corresponds to the piece of dimming glass 1. For example, before the user slides on the display screen 2 in the first direction X, the piece of dimming glass 1 is in the transparent state. After the user slides on the display screen 2 in the first direction X, the controller 4 adjusts transmission states of the driving voltages for the piece of dimming glass 1 (e.g., the driving voltages are transmitted to the piece of dimming glass 1), so that the piece of dimming glass 1 is adjusted to be in the opaque state.

For example, the user double-clicks on the display screen 2. The controller 4 controls the infrared touch apparatus 3 to determine the coordinates of the blocked infrared rays in the infrared detection net, and senses that the touch action of the user is the double-click according to the coordinates. Afterwards, the infrared touch apparatus 3 may generate a corresponding touch signal. Then the controller 4 may obtain the touch signal, and adjust the display image on the display screen 2 and the light transmittance of the piece of dimming glass 1 upon determining that the touch signal corresponds to both the display screen 2 and the piece of dimming glass 1. For example, before the user double-clicks on the display screen 2, the image displayed on the display screen 2 is a piece of clothing, and the piece of dimming glass 1 is in the transparent state. After the user double-clicks on the display screen 2 (e.g., a position where the user double-clicks on the display screen 2 is the same as a position of the image of the clothing), the controller 4 controls the display screen 2 to change the displayed image to an introduction of the clothing (e.g., a brand or a price of the clothing), and adjusts the piece of dimming glass 1 to be in the opaque state.

Therefore, in the touch display system 100 provided in some embodiments of the present disclosure, by providing the display screen 2, the infrared touch apparatus 3 and the controller 4, a display function and a touch control function may be integrated together. That is, the image displayed on the display screen 2 may be adjusted by touching the display screen 2. Moreover, the piece of dimming glass 1 is provided on a side of the display screen 2, and the piece of dimming glass 1 is electrically connected to the controller 4. In a case where there is no need to block light incident toward the display screen 2, the piece of dimming glass 1 may be adjusted to be in the transparent state, so that the light may be transmitted through the piece of dimming glass 1 and incident on the display screen 2. In a case where light incident toward the display screen 2 need to be blocked (the light is transmitted in a direction from the piece of dimming glass 1 to the display screen 2), the piece of dimming glass 1 may be adjusted to be in the opaque state, so as to block the light incident toward the display screen 2 using the piece of dimming glass 1.

In addition, in a case where the touch display system 100 is applied in the window of the vehicle, the piece of dimming glass 1 may be used to replace the traditional curtain, so as to omit the arrangement of the traditional curtain, and reduce the complexity of the internal structure of the vehicle and the probability of abnormality in the internal structure of the vehicle. Moreover, in a process of blocking external light using the piece of dimming glass 1, it is also possible to prevent the piece of dimming glass 1 from blocking the user's viewing of the image displayed on the display screen 2.

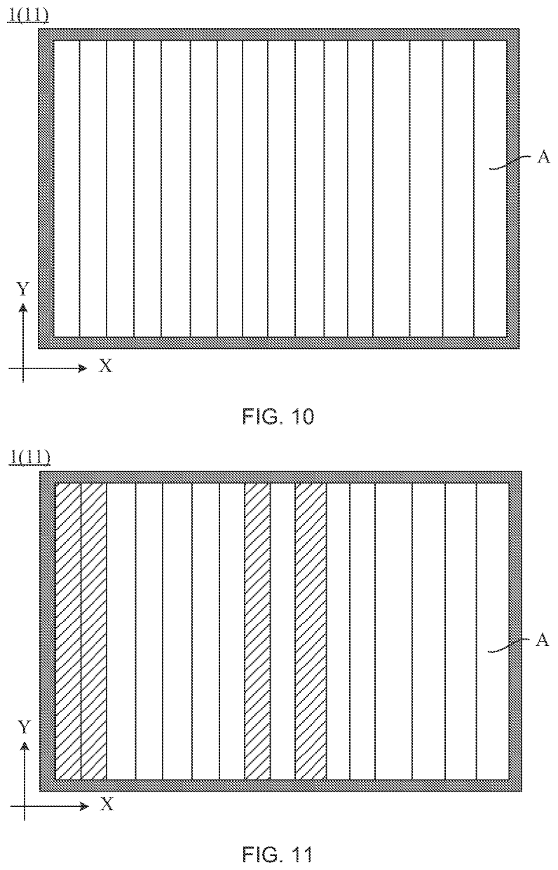

In some examples, as shown in FIGS. 10 and 11, the piece of dimming glass 1 has a plurality of dimming regions A. The controller 4 is configured to independently adjust a light transmittance of each dimming region A in the piece of dimming glass 1. For example, as shown in FIG. 11, from left to right, only the first dimming region A, the second dimming region A, the eighth dimming region A, and the tenth dimming region A are adjusted to be in the opaque state, and other dimming regions A are in the transparent state.

By dividing the plurality of dimming regions A in the piece of dimming glass 1, it is possible to independently adjust the light transmittance by region, so that light transmission effects of the dimming regions A do not affect each other. In a case where the touch display system 100 is applied in the window of the vehicle, compared to the traditional curtain, it is possible to satisfy different demands for light of different users sitting at different positions.

The plurality of dimming regions A include various arrangement manners, which may be selected and set according to actual needs.

In some embodiments, the plurality of dimming regions A may have a square shape and be arranged in an array.

In some other examples, as shown in FIGS. 10 and 11, the plurality of dimming regions A may have a strip shape. A direction in which lengths of the plurality of dimming regions A extend is the second direction Y, and the plurality of dimming regions A may be sequentially arranged in the first direction X.

It will be noted that in a case where the piece of dimming glass 1 has the plurality of dimming regions A, among the at least one piece of dimming sub-glass 11 included in the piece of dimming glass 1, each piece of dimming sub-glass 11 may have a plurality of dimming sub-regions. In a case where the piece of dimming glass 1 includes one piece of dimming sub-glass 11, the plurality of dimming sub-regions are the plurality of dimming regions A. In a case where the piece of dimming glass 1 includes the plurality of pieces of dimming sub-glass 11, one dimming sub-region of one of the pieces of dimming sub-glass 11 may correspond to dimming sub-regions at corresponding positions of other pieces of dimming sub-glass 11 (e.g., sizes of dimming sub-regions are the same, and positions of dimming sub-regions in their respective pieces of dimming sub-glass 11 are the same), and they may form a dimming region A together.

Here, the structure of the piece of dimming glass 1 is schematically described by considering an example where the piece of dimming glass 1 has the plurality of dimming regions A and the piece of dimming glass 1 includes one piece of dimming sub-glass 11.

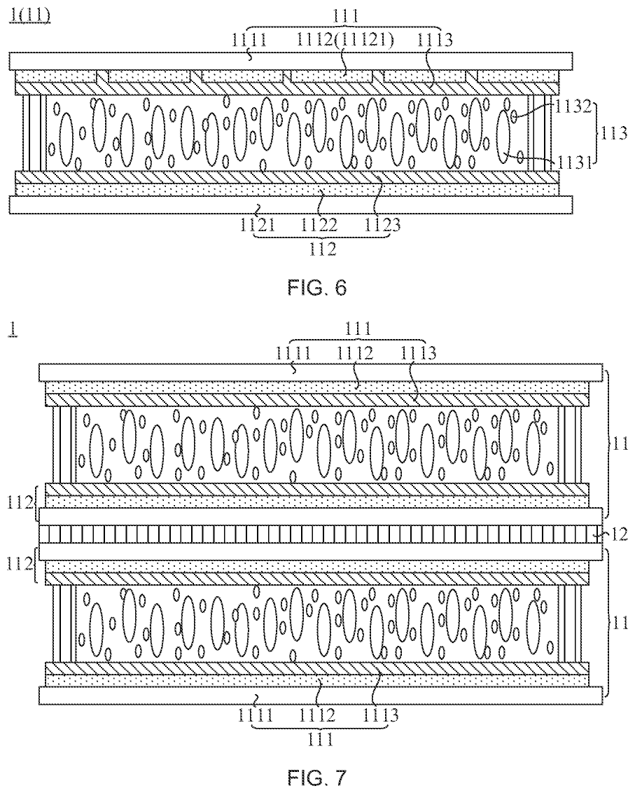

In some examples, as shown in FIGS. 5 and 6, the first electrode layer 1112 included in the first substrate 111 in the piece of dimming glass 1 includes a plurality of first electrodes 11121, and one first electrode 11121 is located in a dimming region A. For example, the first electrodes 11121 may be arranged in one-to-one correspondence with the dimming regions A.

Here, the second electrode layer 1122 included in the second substrate 112 in the piece of dimming glass 1 may have various arrangement manners.

For example, as shown in FIG. 5, the second electrode layer 1122 includes a plurality of second electrodes 11221, and one second electrode 11221 is located in a dimming region A. For example, the second electrodes 11221 may be arranged in one-to-one correspondence with the dimming regions A.

In this way, when a light transmittance of a certain dimming region A is adjusted, it is possible to only transmit or stop transmitting the driving voltages to the first electrode 11121 and the second electrode 11221 that are disposed in the dimming region A, which may achieve an independent control of the light transmittance of the dimming region A, and avoid affecting light transmittances of other dimming regions A.

For example, as shown in FIG. 6, the second electrode layer 1122 covers the plurality of dimming regions A. In this case, the second electrode layer 1122 may be a whole layer of electrode.

In this way, when a certain dimming region A needs to be adjusted to be in the opaque state, the driving voltages may be transmitted to the second electrode layer 1122 and a first electrode 11121 disposed in the dimming region A, and an electric field is generated in a region (i.e. the dimming region A) where the first electrode 11121 and the second electrode layer 1122 are opposite, while no electric field is generated in regions (i.e. the other dimming regions A) where other first electrodes 11121 and the second electrode layer 1122 are opposite. As a result, it is possible to achieve an independent control of the light transmittance of the dimming region A, and avoid affecting light transmittances of other dimming regions A.

In some examples, as shown in FIGS. 7 to 9, the piece of dimming glass 1 includes the plurality of pieces of dimming sub-glass 11 that are arranged in sequence.

In this way, in a case where the driving voltages are applied to the piece of dimming glass 1 to reduce the brightness of the inside of the vehicle by using the dimming glass 1, light may be absorbed by the pieces of dimming sub-glass 11 in turn during the propagation of light being transmitted to the inside of the vehicle, which may be beneficial to completely block light entering from the outside into the inside of the vehicle, and ensure a good light-shielding effect of the piece of dimming glass 1.

The plurality of pieces of dimming sub-glass 11 have various arrangement manners, which may be selected and set according to actual needs.

In some examples, as shown in FIG. 7, the piece of dimming glass 1 further includes an adhesive layer 12 disposed between every two adjacent pieces of dimming sub-glass 11. The adhesive layer 12 is configured to bond every two adjacent pieces of dimming sub-glass 11.

In this way, after the plurality of pieces of dimming sub-glass 11 are independently manufactured, the plurality of pieces of dimming sub-glass 11 may be arranged in sequence and bonded, which may avoid increasing a technological difficulty of manufacturing the piece of dimming sub-glass 1.

Here, a first substrate 111 of one piece of the dimming sub-glass 11 may be bonded to a second substrate 112 of an adjacent piece of dimming sub-glass 11.

Alternatively, the first substrate 111 of one piece of the dimming sub-glass 11 may be bonded to a first substrate 111 of the adjacent piece of dimming sub-glass 11. Alternatively, as shown in FIG. 7, a second substrate 112 of one piece of the dimming sub-glass 11 is bonded to the second substrate 112 of the adjacent piece of dimming sub-glass 11.

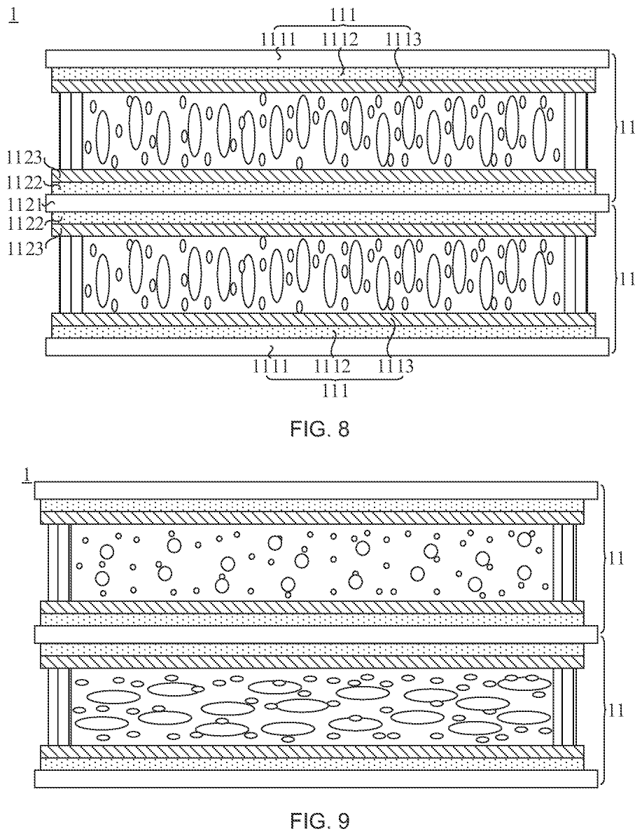

In some other examples, as shown in FIGS. 8 and 9, every two adjacent pieces of dimming sub-glass 11 share a same substrate on sides of the two adjacent pieces of dimming sub-glass 11 that are proximate to each other.

As shown in FIG. 8, it is considered as an example that a second substrate 112 of an upper piece of dimming sub-glass 11 and a second substrate 112 of a lower piece of dimming sub-glass 11 are the same substrate. The substrate includes a second base substrate 1121, second electrode layers 1122 disposed on opposite sides of the second base substrate 1121, and a second alignment layer 1123 disposed on a side of each second electrode layer 1122 away from the second base substrate 1121. In a process of transmitting the driving voltages to the piece of dimming glass 1, a same driving voltage may be transmitted to the second electrode layers 1122 disposed on the opposite sides of the second base substrate 1121.

Every two adjacent pieces of dimming sub-glass 11 share the same substrate on sides of the two adjacent pieces of dimming sub-glass 11 that are proximate to each other, it is possible to simplify the structure of the piece of dimming glass 1 and effectively reduce a thickness of the piece of dimming glass 1, thereby reducing an overall thickness of the touch display system 100. Moreover, it is also possible to reduce waste of materials and cost of the piece of dimming glass 1.

Here, as shown in FIG. 8, a process for manufacturing the piece of dimming glass 1 is schematically illustrated by considering an example where the piece of dimming glass 1 includes two pieces of dimming sub-glass 11 that are stacked in sequence, and the two pieces of dimming sub-glass 11 share the same substrate on sides of the two pieces of dimming sub-glass 11 that are proximate to each other.

For example, the second electrode layers 1122 may be formed on the opposite sides of the second base substrate 1121 by a sputtering deposition process or a physical vapor deposition (PVD) process, and the first electrode layers 1112 are each formed on a side of the first base substrate 1111 by a same process as the second electrode layers 1122. Then, the second alignment layer 1123 may be formed on a side of each second electrode layer 1122 away from the second base substrate 1121 by a coating process and an ultraviolet curing process, and the first alignment layers 1113 are each formed on a side of the first electrode layer 1112 away from the first base substrate 1111 by a same process as the second alignment layer 1123. Next, one of the first alignment layers 1113 is opposed to a second alignment layer 1123, and a sealant is formed between them. A cavity formed by the first alignment layer 1113, the second alignment layer 1123 and the sealant is filled with the liquid crystal molecules 1131 and the dyes 1132, and the cavity is sealed after it is filled, so as to form a piece of dimming sub-glass 11. Afterwards, another piece of dimming sub-glass 11 will be formed by adopting the same steps as a piece of dimming sub-glass 11. In addition, after the piece of dimming sub-glass 11 is formed, a sealant may be formed on edges of the piece of dimming sub-glass to form protection for the piece of dimming sub-glass 11.

In some examples, among the plurality of pieces of dimming sub-glass 11, long axes of liquid crystal molecules 1131 in dye liquid crystal layers 113 of at least two pieces of dimming sub-glass 11 are perpendicular or substantially perpendicular to each other.

On this basis, in the process for manufacturing the plurality of pieces of dimming sub-glass 11, an alignment process may be performed on the alignment layers of the at least two pieces of dimming sub-glass 11.

For example, the alignment process includes a rubbing alignment process. Rubbing directions of the alignment layers of the at least two pieces of dimming sub-glass 11 are perpendicular or substantially perpendicular to each other.

Here, two pieces of dimming sub-glass 11 among the plurality of pieces of dimming sub-glass 11 are considered as an example. For example, a rubbing direction of a first alignment layer 1113 and a second alignment layer 1123 of one piece of dimming sub-glass 11 may form an included angle of 45° with the first direction X. In this case, liquid crystal molecules 1131 in this piece of dimming sub-glass 11 may be arranged in sequence along the rubbing direction and form a certain pretilt angle. A rubbing direction of a first alignment layer 1113 and a second alignment layer 1123 of another piece of dimming sub-glass 11 may form an included angle of −45° with the first direction X. In this case, liquid crystal molecules 1131 in this piece of dimming sub-glass 11 may be arranged in sequence along the rubbing direction and form a certain pretilt angle.

In this way, in a case where no driving voltage is transmitted to the two pieces of dimming sub-glass 11, it is possible to make long axes of liquid crystal molecules 1131 in dye liquid crystal layers 113 of the two pieces of dimming sub-glass 11 perpendicular or substantially perpendicular to each other.

In a case where the driving voltages are transmitted to the two pieces of dimming sub-glass 11, as shown in FIG. 9, the long axes of the liquid crystal molecules 1131 in the two pieces of dimming sub-glass 11 may be still kept perpendicular or substantially perpendicular to each other after the liquid crystal molecules 1131 are deflected. In this case, when light outside the vehicle is incident on the piece of dimming glass 1, the liquid crystal molecules 1131 in the two pieces of dimming sub-glass 11 may be equivalent to two polarizers whose absorption axes are perpendicular to each other, and may absorb light completely (e.g., the light transmittance of the piece of dimming glass 1 in the opaque state may be 1% or less) to form a good shielding effect for light.

Three pieces of dimming sub-glass 11 among the plurality of pieces of dimming sub-glass 11 are considered as an example. For example, a rubbing direction of a first alignment layer 1113 and a second alignment layer 1123 of one piece of dimming sub-glass 11 may form an included angle of 45° with the first direction X (of course, the included angle is not limited to 45°). A rubbing direction of a first alignment layer 1113 and a second alignment layer 1123 of another piece of dimming sub-glass 11 may form an included angle of −45° with the first direction X (of course, the included angle is not limited to −45°). A rubbing direction of a first alignment layer 1113 and a second alignment layer 1123 of yet another piece of dimming sub-glass 11 may form an included angle of 22.5° with the first direction X (of course, the included angle is not limited to 22.5°).

In this case, the piece of dimming sub-glass 11 with the included angle of 22.5° between the rubbing direction of the first alignment layer 1113 and the second alignment layer 1123 and the first direction X may be used to adjust light, so as to further improve the light absorption effect, and the light-shielding effect of the dimming glass 1.

In some examples, among the plurality of pieces of dimming sub-glass 11, dyes 1132 in dye liquid crystal layers 113 of at least two pieces of dimming sub-glass 11 have different colors.

In this way, the dyes 1132 in the dye liquid crystal layers 113 of different pieces of dimming sub-glass 11 may be used to adjust a color of light transmitted through the piece of dimming glass 1. For example, the color of light entering from the outside of the vehicle to the inside of the vehicle through the piece of dimming glass 1 may be changed from white to yellow, so that an environment inside the vehicle will be mild.

For example, the piece of dimming glass 1 including two pieces of dimming sub-glass 11 is considered as an example. A color of dyes 1132 in one piece of dimming sub-glass 11 may be rose red, and a color of dyes 1132 in another piece of dimming sub-glass 11 may be yellow. In this way, a color of light transmitted through the piece of dimming glass 1 may be changed into orange.

In some embodiments, as shown in FIGS. 2, 12 and 13, the infrared touch apparatus 3 in the touch display system 100 includes a frame 31.

A shape of the frame 31 may be same as or substantially same as a shape of the display screen 2 in the touch display system 100. A shape of the piece of dimming glass 1 is same or substantially same as the shape of the display screen 2.

For example, as shown in FIG. 12, the display screen 2 and the frame 31 may have a same or substantially same rectangular shape. For example, the shape of the display screen 2 and the shape of the frame 31 may be a shape shown in FIG. 13.

The frame 31 includes various arrangement manners, which may be selected and set according to actual needs.

For example, the frame 31 may be disposed on the side of the display screen 2 away from the piece of dimming glass 1. In this way, in a process for manufacturing the touch display system 100, the piece of dimming glass 1, the display screen 2 and the infrared touch apparatus 3 may be arranged in sequence, which is beneficial to reduce a difficulty of assembling the touch display system 100 and improve a production efficiency of the touch display system 100.

For another example, as shown in FIG. 2, the frame 31 may be disposed around the piece of dimming glass 1 and the display screen 2. In this way, the piece of dimming glass 1, the display screen 2 and the infrared touch apparatus 3 may be tightly assembled together, so that a compact degree of the piece of dimming glass 1, the display screen 2 and the infrared touch apparatus 3 may be improved, thereby improving a structural stability of the touch display system 100. In addition, it is further beneficial to reducing the thickness of the touch display system 100.

In some examples, the frame 31 includes two groups of sub-frames 311, and each group of sub-frames 311 includes two sub-frames 311 that are arranged opposite to each other.

For example, as shown in FIGS. 12 and 13, sub-frames 311 included in the frame 31 are represented by B1, B2, B3 and B4, respectively. In the two groups of sub-frames 311, one group of sub-frames 311 include B1 and B2 that are arranged opposite to each other and extend in the first direction X, another group of the sub-frames 311 include B3 and B4 that are arranged opposite to each other and extend in the second direction Y.

In some embodiments, as shown in FIGS. 12 and 13, the infrared touch apparatus 3 further includes a plurality of infrared devices 32 disposed on an inner wall of each sub-frame 311.

For example, as shown in FIGS. 12 and 13, in the two sub-frames 311 arranged opposite to each other, infrared devices 32 disposed on an inner wall of one sub-frame 311 are infrared transmitters 321, infrared devices 32 disposed on an inner wall of another sub-frame 311 are infrared detectors 322, and one infrared transmitter 321 is disposed opposite to one infrared detector 322.

For example, infrared devices 32 disposed on an inner wall of B1 may be the infrared transmitters 321, and infrared devices 32 disposed on an inner wall of B2 may be the infrared detectors 322. In this case, each infrared transmitter 321 may transmit an infrared ray extending in the second direction Y, and the infrared ray may be detected by a corresponding infrared detector 322. Infrared devices 32 disposed on an inner wall of B3 may be the infrared transmitters 321, and infrared devices 32 disposed on an inner wall of B4 may be the infrared detectors 322. In this case, each infrared transmitter 321 may transmit an infrared ray extending in the first direction X, and the infrared ray may be detected by a corresponding infrared detector 322.

In this way, infrared devices 32 disposed on the inner walls of the two groups of sub-frames 311 may form the infrared detection net.

In some examples, the plurality of infrared devices 32 disposed on each frame 311 are located on the side of the display screen 2 away from the piece of dimming glass 1. In this way, it may be ensured that the infrared detection net generated by all the infrared devices 32 is located on the side of the display screen 2 away from the piece of dimming glass 1, thereby ensuring that the image displayed on the display screen 2 and/or the light transmittance of the piece of dimming glass 1 may be adjusted by touching the display screen 2.

There are many arrangement positions of the plurality of infrared devices 32 on the inner wall of a corresponding sub-frame 311. The arrangement positions are related to the shape of the frame 31.

In some examples, as shown in FIG. 12, each sub-frame 311 included in the frame 31 has a straight line shape, and ends of every two adjacent sub-frames 311 are connected to each other. That is, the frame 31 has a rectangular shape.

In this case, infrared devices 32 disposed on inner walls of all the sub-frames 311 are disposed in a same plane.

In this way, it is not only ensure that an effective detection region of the formed infrared detection net may cover the display screen 2, but also the infrared touch apparatus 3 have a small thickness.

It will be noted that the effective detection region refers to a region including both the infrared rays extending in the first direction X and the infrared rays extending in the second direction Y.

For example, the plane where the infrared devices 32 disposed on the inner walls of all the sub-frames 311 are located is parallel to the display screen 2.

In this way, distances between infrared rays and the display screen 2 may be equal or approximately equal, which may improve accuracy of the touch display system 100.

In some other examples, as shown in FIG. 13, the frame 31 further includes at least one transition portion 312. That is, the frame 31 includes one transition portion 312, or a plurality of transition portions 312. Each transition portion 312 has an arc shape, and is connected between ends, proximate to each other, of two adjacent sub-frames 311.

Here, as shown in FIG. 13, the frame 31 including one transition portion 312 is considered as an example. Two sub-frames 311 connected to the transition portion 312 are respectively a first sub-frame (which may be B1) and a second sub-frame (which may be B3).

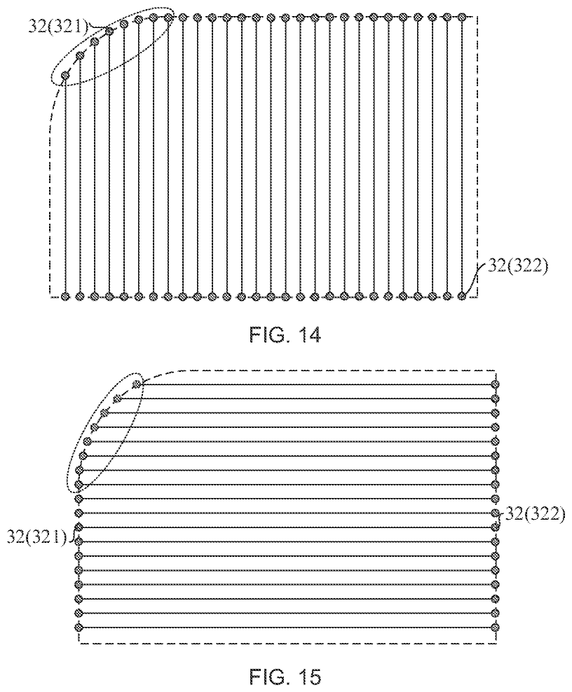

For example, as shown in FIGS. 14 and 15, a first group of infrared devices 32 and a second group of infrared devices 32 are disposed on an inner wall of the transition portion 312. The first group of infrared devices 32 and the plurality of infrared devices 32 disposed on B1 are of a same type and are located in a first plane. That is, the first group of infrared devices 32 are the infrared transmitters 321. The second group of infrared devices 32 and the plurality of infrared devices 32 disposed on B3 are of a same type and are located in a second plane. That is, the second group of infrared devices 32 are the infrared transmitters 321.

For example, the first plane and the second plane are different planes parallel to the display screen 2. As shown in FIG. 13, it may be seen from a top view that the first group of infrared devices 32 may overlap with the second group of infrared devices 32. By providing the first group of infrared devices 32 and the second group of infrared devices 32 on different planes, it is possible to avoid a situation that a certain infrared device 32 in the first group of infrared devices 32 or in the second group of infrared devices 32 has no space for placement, thereby ensuring that the effective detection region of the infrared detection net formed by the infrared devices 32 disposed in the frame 31 may cover the display screen 2.

The number of the transition portion 312 is related to the shape of the display screen 2, which may be selected and set according to actual needs.

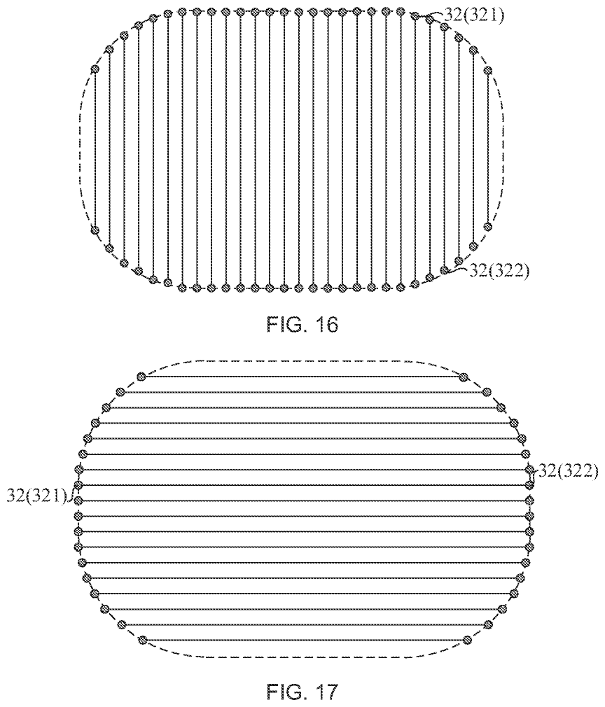

In some examples, every two adjacent sub-frames 311 are connected to a transition portion 312 therebetween. In this case, for an arrangement manner of the infrared devices 32, reference may be made to the arrangement manner shown in FIGS. 16 and 17, so as to ensure that each infrared device 32 has a space to be placed, and the effective detection region of the formed infrared detection net may cover the display screen 2.

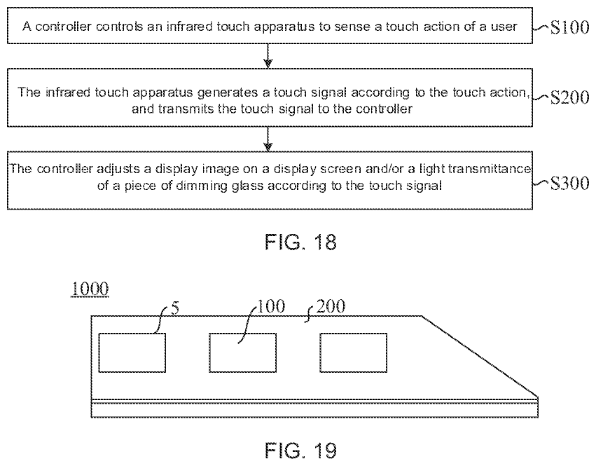

In some embodiments of the present disclosure, a driving method for a touch display system is provided. The driving method is applied to the touch display system 100 provided in the embodiments described above. As shown in FIG. 18, the driving method includes steps 100 to 300 (S100 to S300).

In S100, a controller controls an infrared touch apparatus to sense a touch action of a user.

In S200, the infrared touch apparatus generates a touch signal according to the touch action, and transmits the touch signal to the controller.

In a case where the user touches a display screen, infrared rays corresponding to a touch position will be blocked. In this case, the controller may control the infrared touch apparatus to determine coordinates of the blocked infrared rays, and further sense the touch action of the user.

After sensing the touch action of the user, the infrared touch apparatus may generate a corresponding touch signal and transmit the touch signal to the controller.

In S300, the controller adjusts a display image on the display screen and/or a light transmittance of a piece of dimming glass according to the touch signal.

After receiving the touch signal, the controller may make a determination on the touch signal. For example, an adjustment object corresponding to the touch signal and an adjustment content corresponding to the touch signal are determined.

After determining the touch signal, the display image on the display screen and/or the light transmittance of the piece of dimming glass may be controlled to make a corresponding adjustment.

The beneficial effects achieved by the driving method for the touch display system provided in some embodiments of the present disclosure are the same as the beneficial effects achieved by the touch display system 100 provided in some of the embodiments described above, which will not be repeated here.

In some embodiments of the present disclosure, a vehicle 1000 is provided. As shown in FIG. 19, the vehicle 1000 includes a vehicle body 200 and at least one touch display system 100 provided in some of the embodiments described above. The vehicle body 200 has a plurality of windows 5. At least one window is provided therein with a piece of dimming glass 1, a display screen 2 and an infrared touch apparatus 3 of the touch display system 100.

In some examples, a shape and a size of a window 5 may be respectively same or approximately same as a shape and a size of the piece of dimming glass 1 or the display screen 2.

In some examples, after the touch display system 100 is provided in the window 5, the piece of dimming glass 1 is proximate to the outside of the vehicle, and the display screen 2 is proximate to the inside of the vehicle. The controller 4 of the touch display system 100 may be disposed inside the vehicle body 200 and located in a position proximate to the display screen 2 and the piece of dimming glass 1.

In some embodiments, the vehicle 1000 may be an equipment such as a car, a train, a bullet train, or a high-speed railway train.

The foregoing descriptions are merely specific implementation manners of the present disclosure, but the protection scope of the present disclosure is not limited thereto. Any changes or replacements that a person skilled in the art could conceive of within the technical scope of the present disclosure shall be included in the protection scope of the present disclosure. Therefore, the protection scope of the present disclosure shall be subject to the protection scope of the claims.

1. A touch display system, comprising:
a piece of dimming glass;
a transparent display screen disposed on a side of the piece of dimming glass;
an infrared touch apparatus, the infrared touch apparatus being configured to generate an infrared detection net on a side of the display screen away from the piece of dimming glass; and
a controller electrically connected to the piece of dimming glass, the display screen and the infrared touch apparatus, the controller being configured to control the infrared touch apparatus to sense a touch action of a user, obtain a touch signal sensed by the infrared touch apparatus, and adjust at least one of a display image on the display screen and/or a light transmittance of the piece of dimming glass according to the touch signal.

2. The touch display system according to claim 1, wherein the piece of dimming glass includes at least one piece of dimming sub-glass; and each piece of dimming sub-glass includes:
a transparent first substrate;
a transparent second substrate, the first substrate and the second substrate being disposed opposite to each other; and
a dye liquid crystal layer disposed between the first substrate and the second substrate.

3. The touch display system according to claim 2, wherein the piece of dimming glass includes a plurality of pieces of dimming sub-glass that are arranged in sequence; and
among the plurality of pieces of dimming sub-glass, long axes of liquid crystal molecules in dye liquid crystal layers of at least two pieces of dimming sub-glass are substantially perpendicular to each other.

4. The touch display system according to claim 3, wherein among the plurality of pieces of dimming sub-glass, dyes in dye liquid crystal layers of at least two pieces of dimming sub-glass have different colors.

5. The touch display system according to claim 3, wherein every two adjacent pieces of dimming sub-glass share a same substrate on sides of the two adjacent pieces of dimming sub-glass proximate to each other.

6. The touch display system according to claim 1, wherein the piece of dimming glass has a plurality of dimming regions; and
the controller is configured to independently adjust a light transmittance of each dimming region in the piece of dimming glass.

7. The touch display system according to claim 6, wherein the dimming regions have a strip shape, a direction in which lengths of the dimming regions extend is a second direction, and the plurality of dimming regions are arranged sequentially in a first direction;
the first direction intersects with the second direction.

8. The touch display system according to claim 6, wherein the piece of dimming glass includes at least one piece of dimming sub-glass; and each piece of dimming sub-glass includes a transparent first substrate, a transparent second substrate opposite to the first substrate, and a dye liquid crystal layer disposed between the first substrate and the second substrate;
the first substrate includes a first electrode layer; the first electrode layer includes a plurality of first electrodes, and one first electrode is located in a dimming region; and
the second substrate includes a second electrode layer; the second electrode layer includes a plurality of second electrodes, and one second electrode is located in the dimming region in which the first electrode is located; or the second electrode layer covers the plurality of dimming regions.

9. The touch display system according to claim 1, wherein the infrared touch apparatus includes:
a frame, the frame including two groups of sub-frames, and each group of sub-frames including two sub-frames that are disposed opposite to each other; and
a plurality of infrared devices disposed on an inner wall of each sub-frame; the plurality of infrared devices being located on the side of the display screen away from the piece of dimming glass, wherein
in two sub-frames that are disposed opposite to each other, infrared devices disposed on an inner wall of one of the two sub-frames are infrared transmitters, infrared devices disposed on an inner wall of another of the two sub-frames are infrared detectors, and one infrared transmitter is disposed opposite to one infrared detector.

10. The touch display system according to claim 9, wherein the sub-frames have a straight line shape, and ends of every two adjacent sub-frames are connected to each other; and
infrared devices disposed on inner walls of all sub-frames are disposed in a same plane parallel to the display screen.

11. The touch display system according to claim 9, wherein the frame further includes at least one transition portion having an arc shape, and a transition portion is connected between ends, proximate to each other, of two adjacent sub-frames;
the two sub-frames connected to the transition portion are respectively a first sub-frame and a second sub-frame;
an inner wall of the transition portion is provided with a first group of infrared devices and a second group of infrared devices thereon;
the first group of infrared devices and infrared devices disposed on the first sub-frame have a same type, and are located in a first plane; and
the second group of infrared devices and infrared devices disposed on the second sub-frame have a same type, and are located in a second plane; wherein
the first plane and the second plane are different planes that are parallel to the display screen.

12. The touch display system according to claim 11, wherein every two adjacent sub-frames are connected to a transition portion therebetween.

13. The touch display system according to claim 9, wherein the frame is disposed around the piece of dimming glass and the display screen.

14. A driving method for a touch display system applied to the touch display system according to claim 1, the driving method comprising:
controlling, by the controller, the infrared touch apparatus to sense the touch action of the user;
generating, by the infrared touch apparatus, the touch signal according to the touch action,
transmitting, by the infrared touch apparatus, the touch signal to the controller; and
adjusting, by the controller, at least one of the display image on the display screen and the light transmittance of the piece of dimming glass according to the touch signal.

15. A vehicle, comprising:
a vehicle body, the vehicle body having a plurality of windows; and
at least one touch display system according to claim 1, and at least one window is provided therein with the piece of dimming glass, the transparent display screen and the infrared touch apparatus of a touch display system.

16. The vehicle according to claim 15, wherein the controller of the touch display system is disposed inside the vehicle body.

17. The touch display system according to claim 5, wherein the substrate includes a base substrate, and electrode layers disposed on opposite sides of the base substrate.

18. The touch display system according to claim 6, wherein the dimming regions have a square shape, and are arranged in an array.
